(19) United States
(12) Patent Application Publication
(10) Pub. No.: US 2006/0134334 A1
(43) Pub. Date: Jun. 22, 2006

(54) Process for the production of primer surfacer-free multi-layer coatings

(76) Inventors: Marc Chilla, Sprockhoevel (DE); Giannoula Avgenaki, Duesseldorf (DE); Volker Paschmann, Essen (DE)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/019,558

(22) Filed: Dec. 22, 2004

(51) Int. Cl. B05D 3/02; B05D 1/36

(52) U.S. Cl. 427/372.2; 427/402

(57) ABSTRACT

A process for the production of multi-layer coatings, comprising the successive steps: 1) applying a 10 to 35 μm thick base coat layer onto a substrate provided with an EDC primer, 2) applying a clear coat layer onto the base coat layer, 3) jointly curing the base coat and clear coat layers, wherein the base coat layer is applied in a first layer and in a second layer; the first layer comprises a modified water-borne base coat produced by mixing an unmodified water-borne base coat with a pigmented admixture component and the second layer comprises the unmodified water-borne base coat, wherein the admixture component contains at least one polyisocyanate, has a ratio by weight of pigment content to resin solids content of 0.05:1 to 0.5:1 and is mixed into the unmodified water-borne base coat in a ratio by weight of 0.2 to 1 parts of polyisocyanate: 1 part of resin solids of the unmodified water-borne base coat, and wherein the pigment content of the admixture component comprises at least one pigment which effectively reduces UV transmission and wherein the pigment content is made in such a way that UV light can penetrate through the base coat layer formed from modified water-borne base coat and unmodified water-borne base coat only in accordance with a UV transmission of less than 0.1% in the wavelength range of from 280 to 380 nm and of less than 0.5% in the wavelength range of from 380 to 400 nm.

### FIELD OF THE INVENTION

The invention relates to a process for the production of primer surfacer-free (comprising no filler layer) multi-layer coatings.

### DESCRIPTION OF THE PRIOR ART

Automotive coatings consist, as a rule, of a separately baked electrodeposition coating (EDC) primer, a separately baked primer surfacer layer (filler layer) applied thereto and a top coat applied thereto comprising a wet-on-wet applied color- and/or special effect-imparting base coat layer and a protective, gloss-imparting clear coat layer. The total primer surfacer plus base coat layer thickness is generally 30 to 60 μm.

A process is known from WO 97/47401 for the production of decorative multi-layer coatings, which process allows for the elimination of the application and separate baking of a primer surfacer layer which, of course, reduces coating material consumption and the total layer thickness. In this process, a multi-layer coating structure comprising a first, modified water-borne base coat, a second, unmodified water-borne base coat and a clear coat is applied by a wet-on-wet-on-wet process comprising the joint curing of these three coating layers that are applied to a baked EDC primer. In practice, this process uses two base coat layers that allow for markedly lower total layer thicknesses by approximately 15 to 25 μm, than that of a conventional primer surfacer and base coat. The modified water-borne base coat is produced in this process from an unmodified water-borne base coat by mixing with an admixture component in the form of polyisocyanate or a polyisocyanate preparation and is intended to replace the function of a conventional primer surfacer.

A weakness of the process known from WO 97/47401 is that it is not readily possible to produce multi-layer coatings in certain color shades (“problematic color shades”). The reason is UV light (UV radiation), as a constituent of natural daylight, passes through the coating layers applied to the EDC primer to the surface of the EDC primer to a noticeable extent in the absence of a primer surfacer layer and causes degradation of the EDC primer.

The color shades which are problematic with regard to the production of primer surfacer-free multi-layer coatings are those which, while (like unproblematic color shades) providing a coating which appears to an observer to be opaque, permit an inadmissibly large amount of UV light to penetrate through the multi-layer structure of clear coat, unmodified water-borne base coat and modified water-borne base coat to the surface of the EDC primer and cause long term damage to the EDC layer. Such problematic color shades are to be found both among single (plain) color shades and special effect color shades. Examples may, in particular, be found among water-borne base coats with dark blue single color shades based on phthalocyanine pigments and among water-borne base coats with specific special effect color shades, for example, dark blue metallic color shades or light metallic color shades, such as, in particular, silver color shades and among water-borne base coats with specific special effect color shades containing elevated proportions of mica pigments in the pigment content. In the case of the problematic color shades, the UV light may penetrate through the multi-layer coating structure, for example, to an extent exceeding the specified UV transmission level and reaches the EDC layer. Car manufacturers' specifications state, for example, that UV transmission through the base coat layer in the area of the complete outer skin of the vehicle body should amount to less than 0.1% in the wavelength range of from 280 to 380 nm and less than 0.5% in the wavelength range of from 380 to 400 nm. The possible undesired long-term consequences of an inadmissible level of UV light penetration to the EDC layer are chalking of the EDC layer and delamination of the multi-layer coating over the service life of the coated substrates.

Alternatively, the modified and/or the unmodified water-borne base coat could be applied in an overall higher layer thickness sufficient to prevent to an adequate degree the access of UV light to the EDC primer. However, this would be a backward technological step in the direction of high total film thickness.

The use of UV absorbers in clear coats or base coats is known, for example, from U.S. Pat. No. 5,574,166 and WO 94/18278, and is a solution to the problem of delamination. However, UV absorbers cannot be used to a very great extent in the base coat layers and/or the clear coat layer because of the migration tendency of the UV absorbers and because of the gradual degradation of the UV absorbers, as well as for cost reasons.

Other solutions, which approach the delamination problem from the EDC side are known from EP 0 576 943, U.S. Pat. No. 6,368,719, U.S. 2003/0054193 A1 and U.S. 2003/0098238 A1. These disclose the use of EDC coating compositions which are resistant to the action of UV light due to specially selected binders or due to the addition of suitable additives. This inevitably restricts the EDC composition, such that concessions may have to be made in relation to other technological properties, such as, for example, corrosion protection.

### SUMMARY OF THE INVENTION

Surprisingly, the advantages of the process according to WO 97/47401 (dispensing with application of primer surfacer and providing low total film thickness) may be retained while nevertheless sufficiently suppressing access of UV light, which is destructive over the long term, to the EDC primer if the unmodified water-borne base coat is modified with a polyisocyanate preparation pigmented in a specific manner as an admixture component instead of the admixture component known from WO 97/47401 in the form of pigment-free polyisocyanate or a pigment-free polyisocyanate preparation. UV transmission through the base coat layer formed of modified water-borne base coat and unmodified water-borne base coat may then be adjusted to less than 0.1% in the wavelength range of from 280 to 380 nm and to less than 0.5% in the wavelength range of from 380 to 400 nm, whereby, for example, corresponding car manufacturers' specifications may be fulfilled.

The invention is directed to a process for the production of multi-layer coatings, comprising the successive steps:

1) applying a 10 to 35 μm thick base coat layer to a substrate provided with an EDC primer,

2) applying a clear coat layer onto the base coat layer,

3) jointly curing the base coat and clear coat layers,

wherein the base coat layer is applied in a first layer and in a second layer; the first layer comprises a modified water-borne base coat produced by mixing an unmodified water-borne base coat with a pigmented admixture component and the second layer comprises the unmodified water-borne base coat,

wherein the admixture component contains one or more polyisocyanates, has a ratio by weight of pigment content to resin solids content of 0.05:1 to 0.5:1, in particular of 0.1:1 to 0.4:1, and is mixed into the unmodified water-borne base coat in a ratio by weight of 0.2 to 1, preferably 0.2 to 0.8 parts of polyisocyanate: 1 part of resin solids of the unmodified water-borne base coat,

wherein the pigment content of the admixture component comprises at least one pigment which effectively reduces UV transmission and wherein the pigment content is made (composed) in such a way that UV light can penetrate through the base coat layer formed from modified water-borne base coat and unmodified water-borne base coat only in accordance with a UV transmission of less than 0.1% in the wavelength range of from 280 to 380 nm and of less than 0.5% in the wavelength range of from 380 to 400 nm.

### DETAILED DESCRIPTION OF THE EMBODIMENTS

The term “pigment content” means the sum of all the pigments contained in a coating composition without fillers (extenders). The term “pigments” is used here as in DIN 55944 and covers, in addition to special effect pigments, inorganic white, colored and black pigments and organic colored and black pigments. At the same time, therefore, DIN 55944 distinguishes between pigments and fillers.

The description and the claims mention “pigments which effectively reduce UV transmission”. Obviously, all pigments ultimately reduce UV transmission, but to a differing extent depending on the pigment, such that a distinction can be drawn between two groups of pigments, those exhibiting stronger UV absorption or UV reflection and those exhibiting weaker UV absorption or UV reflection. Accordingly, the phrase “pigment which effectively reduces UV transmission” means a pigment, which is sufficiently suited to reducing UV transmission for the purposes of the process according to the invention.

In the process according to the invention conventional substrates provided with an EDC primer are coated. In particular, the substrates are automotive bodies or body parts provided with an EDC primer, in particular, a cathodic electrodeposition (CED) coating. The production of substrates provided with an EDC primer is known to the person skilled in the art. There are no restrictions with regard to the selection of the EDC primer; in particular, EDC primers are also suitable which would be damaged by long-term exposure to UV light.

The substrates having an EDC primer are provided, first of all, with a base coat layer in a process film thickness in the range from 10 to 35 μm. The base coat layer is applied in two layers, i.e., a first layer, for example, 5 to 25 μm thick of a modified water-borne base coat produced by mixing an unmodified water-borne base coat with an admixture component is applied and a subsequent second layer, for example, 3 to 15 μm thick of the unmodified water-borne base coat then is applied. The total film thickness of the base coat layer is dependent inter alia on color shade; car manufacturers' requirements for base coat film thickness are expressed in the so-called process film thickness (average film thickness which is desired over the entire body in the automotive original coating process), which is directed towards the film thickness for each base coat color shade required to achieve the desired color shade on the substrate and to achieve technological properties (e.g., stone chip resistance) and towards an economic application of the relevant water-borne base coat, i.e., in as thin a film as possible. The total base coat film thickness ranges from 10 to 35 μm and is the sum of, for example, 5 to 25 μm of the modified water-borne base coat plus, for example, 3 to 15 μm of the unmodified water-borne base coat. Such film thicknesses for base coats meet the requirements for coating the relevant substrates, for example, automotive bodies. In particular, this means that a specific value within this range from 10 to 35 μm represents the process film thickness for a particular individual base coat. Said specific process film thickness is here composed of the sum of the specific process film thickness, lying within the range of, for example, 5 to 25 μm, of the corresponding modified water-borne base coat and the specific process film thickness, lying within the range of, for example, 3 to 15 μm of the corresponding unmodified water-borne base coat.

The film thicknesses indicated in the present description and in the claims for coating layers refer in each case to dry film thicknesses.

In the description and in the claims, a distinction is drawn between unmodified and modified water-borne base coats.

The unmodified water-borne base coats, from which the modified water-borne base coats may be produced by mixing with the admixture component containing one or more polyisocyanates and having a pigment content, are aqueous coating compositions having a ratio by weight of pigment content to resin solids content of, for example, 0.05:1 to 0.6:1. In addition to water, a resin solids content, which comprises binder(s), optionally, paste resin(s) and optionally, cross-linking agent(s), pigment(s), optionally, filler(s) and optionally, organic solvent(s), the unmodified water-borne base coats contain in general also conventional additive(s).

The unmodified water-borne base coats contain ionically and/or non-ionically stabilized binder systems. These are preferably anionically and/or non-ionically stabilized. Anionic stabilization is preferably achieved by at least partially neutralized carboxyl groups in the binder, while non-ionic stabilization is preferably achieved by lateral or terminal polyethylene oxide units in the binder. The unmodified water-borne base coats may be physically drying or crosslinkable by formation of covalent bonds. The crosslinkable unmodified water-borne base coats forming covalent bonds may be self- or externally crosslinkable systems.

The unmodified water-borne base coats contain one or more conventional film-forming binders. They may optionally also contain crosslinking agents if the binders are not self-crosslinkable or physically drying. Examples of film-forming binders, which may be used, are conventional polyester, polyurethane, (meth)acrylic copolymer resins and/or hybrid binders derived from these classes of binder. Selection of the optionally contained crosslinking agents depends, in a manner familiar to the person skilled in the art, on the functionality of the binders, i.e., the crosslinking agents are selected in such a way that they exhibit a reactive functionality complementary to the functionality of the binders. Examples of such complementary functionalities between binder and crosslinking agent are: carboxyl/epoxy, hydroxyl/methylol ether and/or methylol (methylol ether and/or methylol preferably, as crosslinkable groups of amino resins, in particular, melamine resins).

The unmodified water-borne base coats contain conventional pigments, for example, special effect pigments and/or pigments selected from among white, colored and black pigments.

Examples of special effect pigments are conventional pigments which impart to a coating color flop and/or lightness flop dependent on the angle of observation, such as, non-leafing metal pigments, for example, of aluminum, copper or other metals, interference pigments, such as, for example, metal oxide-coated metal pigments, for example, iron oxide-coated aluminum, coated mica, such as, for example, titanium dioxide-coated mica, graphite effect-imparting pigments, iron oxide in flake form, liquid crystal pigments, coated aluminum oxide pigments, coated silicon dioxide pigments.

Examples of white, colored and black pigments are the conventional inorganic or organic pigments known to the person skilled in the art, such as, for example, titanium dioxide, iron oxide pigments, carbon black, azo pigments, phthalocyanine pigments, quinacridone pigments, pyrrolopyrrole pigments, and perylene pigments.

The unmodified water-borne base coats are those with problematic color shades, i.e., water-borne base coats which are distinguished in that UV light corresponding to a UV transmission of more than 0.1% in the wavelength range of from 280 to 380 nm and of more than 0.5% in the wavelength range of from 380 to 400 nm may penetrate through a base coat layer applied in the process film thickness and consisting of a relevant water-borne base coat modified with pigment-free polyisocyanate in a ratio by weight of 0.2 to 1 parts of polyisocyanate: 1 part of resin solids of the unmodified water-borne base coat and the corresponding unmodified water-borne base coat. In other words, the unmodified water-borne base coats with problematic color shades have such low levels of pigmentation (ratio by weight of pigment content to resin solids content) and/or such pigment contents that, by virtue of the type and proportion of the constituent pigments, UV light corresponding to a UV transmission of more than 0.1% in the wavelength range of from 280 to 380 nm and of more than 0.5% in the wavelength range of from 380 to 400 nm may penetrate through a base coat layer applied in the process film thickness and consisting of a relevant water-borne base coat modified with pigment-free polyisocyanate in a ratio by weight of 0.2 to 1 parts of polyisocyanate: 1 part of resin solids of the unmodified water-borne base coat and the corresponding unmodified water-borne base coat. The unmodified water-borne base coats with problematic color shades accordingly have excessively low levels of pigmentation and/or pigment contents without or with excessively small proportions of pigments which effectively reduce UV transmission. Such unmodified water-borne base coats with problematic color shades may be found among unmodified water-borne base coats both with single color shades and with special effect color shades. Examples may in particular be found among water-borne base coats with dark blue single color shades based on phthalocyanine pigments and among water-borne base coats with specific special effect color shades, for example, dark blue metallic color shades or light metallic color shades, such as, in particular, silver color shades and among water-borne base coats with specific special effect color shades containing elevated proportions of mica pigments in the pigment content.

UV transmission may be measured by applying a corresponding coating structure of modified water-borne base coat and unmodified water-borne base coat to a UV light-transmitting support, for example, a silica glass plate, and measuring the UV transmission in the corresponding wavelength range using a corresponding uncoated UV light-transmitting support as reference. It is self-explanatory that in order to correctly determine the difference in UV transmission between a base coat structure produced according to the invention making use of the pigmented admixture component and a corresponding base coat structure produced according to the prior art making use of a pigment-free polyisocyanate admixture component, it is necessary to work under similar conditions. With regard to the invention this means, in particular, to choose in both cases the same ratio by weight between polyisocyanate and resin solids of the unmodified water-borne base coat within the stated range of 0.2 to 1 parts: 1 part.

The unmodified water-borne base coats may also contain fillers, for example, in proportions of 0 to 30 wt. % relative to the resin solids content. The fillers do not constitute part of the pigment content of the unmodified water-borne base coats. Examples are barium sulfate, kaolin, talcum, silicon dioxide, layered silicates and any mixtures thereof.

The special effect pigments are generally initially introduced in the form of a conventional commercial aqueous or non-aqueous paste, optionally, combined with preferably water-dilutable organic solvents and additives and then mixed with aqueous binder. Pulverulent special-effect pigments may first be processed with preferably water-dilutable organic solvents and additives to yield a paste.

White, colored and black pigments and/or fillers may, for example, be ground in a proportion of the aqueous binder. Grinding may preferably also take place in a special aqueous paste resin. Grinding may be performed in conventional assemblies known to the person skilled in the art. The formulation is then completed with the remaining proportion of the aqueous binder or of the aqueous paste resin.

The unmodified water-borne base coats may contain conventional additives in conventional quantities, for example, of 0.1 to 5 wt. %, relative to the solids content thereof. Examples are antifoaming agents, wetting agents, adhesion promoters, catalysts, levelling agents, anticratering agents, thickeners and light stabilizers, for example, UV absorbers and/or HALS-based compounds (HALS, hindered amine light stabilizers). If the unmodified water-borne base coats contain light stabilizers, these are by no means solely responsible for UV light being able to penetrate through the base coat layer formed from modified water-borne base coat and unmodified water-borne base coat only in accordance with a UV transmission of less than 0.1% in the wavelength range of from 280 to 380 nm and of less than 0.5% in the wavelength range of from 380 to 400 nm. This effect is instead, in particular with regard to the durability thereof, achieved by using the pigmented admixture component containing one or more polyisocyanates.

The unmodified water-borne base coats may contain conventional solvents, for example, in a proportion of preferably less than 20 wt. %, particularly preferably, less than 15 wt. %. These are conventional coating solvents, which may originate, for example, from production of the binders or are added separately. Examples of such solvents are alcohols, for example, propanol, butanol, hexanol; glycol ethers or esters, for example, diethylene glycol di-C1-C6-alkyl ether, dipropylene glycol di-C1-C6-alkyl ether, ethoxypropanol, ethylene glycol monobutyl ether; glycols, for example, ethylene glycol and/or propylene glycol, and the di- or trimers thereof; N-alkylpyrrolidone, such as, for example, N-methylpyrrolidone; ketones, such as, methyl ethyl ketone, acetone, cyclohexanone; aromatic or aliphatic hydrocarbons, for example, toluene, xylene or linear or branched aliphatic C6-C12 hydrocarbons.

The unmodified water-borne base coats have solids contents of, for example, 10 to 40 wt. %, preferably, of 15 to 30 wt. %.

The modified water-borne base coats may be produced from the unmodified water-borne base coats by mixing with the pigmented admixture component containing one or more polyisocyanates.

The addition of the admixture component to the unmodified water-borne base coats imparts to the resultant modified water-borne base coats technological properties, such as, for example, stone chip resistance, which are important to the finished multi-layer coating.

The unmodified water-borne base coat and the admixture component are preferably mixed on the user's premises shortly or immediately before application of the modified water-borne base coat. In the case of industrial coating facilities, the unmodified water-borne base coats in each case of a different color shade are each guided in their own circulating line. In the process according to the invention, it is possible to work with only one admixture component or two or more, for example, 2 to 5, in each case differently pigmented admixture components. It may be expedient to use more than one admixture component, each having different pigmentation, if the water-borne base coat is applied in a color shade program with two or more color shades and it is desired to make an adjustment between the particular color shades of the unmodified water-borne base coats and the color shade of the pigmented admixture component. For example, in the case of a light color shade of an unmodified water-borne base coat, the person skilled in the art will tend to select an admixture component with a light-colored pigment content. The admixture component or admixture components, like the differently colored unmodified water-borne base coats, are in each case conveyed in a dedicated circulating line and automatically mixed with the particular unmodified water-borne base coat using mixing technology conventional in industrial coating facilities, for example, by means of a Kenics mixer. When applying water-borne base coat in a color shade program of n color shades, it is therefore not necessary to provide for instance 2n circulating lines (in each case n circulating lines for the different colors of the unmodified water-borne base coats and for the different colors of the modified water-borne base coats), but rather just n circulating lines for the different colors of the unmodified water-borne base coats plus m, for example, 1 to 5, circulating lines for the pigmented admixture component(s). In the event that the color shade program also comprises unproblematic color shades, the corresponding unmodified water-borne base coats need not necessarily be mixed with the or one of the pigmented admixture components for the purpose of preparing the modified water-borne base coats, but it is instead possible in these cases also to work with a corresponding pigment-free admixture component, for example, the admixture component known from WO 97/47401 in the form of a pigment-free polyisocyanate or a pigment-free polyisocyanate preparation; however, this approach entails an additional circulating line for the pigment-free admixture component.

The admixture component containing one or more polyisocyanates and comprising a pigment content is a composition with a solids content of 30 to 100 wt. %, in general, of 40 to 95 wt. %, in particular, of 55 to 95 wt. % and specifically, of 65 to 95 wt. %. The volatile content is formed, in addition to possible volatile additives, by water and/or organic solvent. The solids content itself consists of the resin solids content plus the pigments forming the pigment content, optionally, plus fillers and optionally, plus nonvolatile additives. Fillers do not constitute part of the pigment content. The ratio by weight of pigment content to resin solids content is 0.05:1 to 0.5:1, in particular 0.1:1 to 0.4:1. The value of this ratio is the result of the fundamentally selected ratio of pigments to resin solids content and of the specific weight of the individual pigments forming the pigment content.

The resin solids content of the admixture component comprises one or more polyisocyanates and optionally, one or more resins used as a separate pigment grinding medium or as a pigment grinding auxiliary (“grinding” or “paste” resins). In general, the resin solids content consists to an extent of 100 wt. % of polyisocyanate(s) or, for example, of 85 to 99 wt. % of polyisocyanate(s) plus 1 to 15 wt. % of grinding resin(s), wherein the weight percentages add up to 100 wt. %.

The term “polyisocyanate(s)” used in connection with the admixture component is not restricted to the meaning free polyisocyanate or free polyisocyanates, but instead also includes blocked polyisocyanate or blocked polyisocyanates. The polyisocyanate(s) contained in the admixture component accordingly comprise one or more free polyisocyanates, one or more blocked polyisocyanates or a combination of one or more free polyisocyanates and one or more blocked polyisocyanates. Free polyisocyanates are preferred.

The polyisocyanates comprise di- and/or polyisocyanates with aliphatically, cycloaliphatically, araliphatically and/or less preferably aromatically attached isocyanate groups.

The polyisocyanates are liquid at room temperature or are present as an organic solution; the polyisocyanates here exhibit at 23° C. a viscosity of in general 0.5 to 2000 mPa·s. The isocyanate content of the polyisocyanates present in the form of free or latent (blocked, thermally re-dissociable) isocyanate groups is in general in a range from 2 to 25 wt. %, preferably, from 5 to 25 wt. % (calculated as NCO).

Examples of diisocyanates are hexamethylene diisocyanate, tetramethylxylylene diisocyanate, isophorone diisocyanate, dicyclohexylmethane diisocyanate, and cyclohexane diisocyanate.

Examples of polyisocyanates are those which contain heteroatoms in the residue linking the isocyanate groups. Examples of these are polyisocyanates which contain carbodiimide groups, allophanate groups, isocyanurate groups, uretidione groups, urethane groups, acylated urea groups or biuret groups. The polyisocyanates preferably have an isocyanate functionality higher than 2, such as, for example, polyisocyanates of the uretidione or isocyanurate type produced by di- or trimerization of the above-mentioned diisocyanates. Further examples are polyisocyanates produced by reaction of the above-mentioned diisocyanates with water and containing biuret groups or polyisocyanates produced by reaction with polyols and containing urethane groups.

Of particular suitability are, for example, “coating polyisocyanates” based on hexamethylene diisocyanate, isophorone diisocyanate or dicyclohexylmethane diisocyanate. “Coating polyisocyanates” based on these diisocyanates means the per se known biuret, urethane, uretidione and/or isocyanurate group-containing derivatives of these diisocyanates.

As already mentioned above, the polyisocyanates may be used in blocked form, though this is not preferred. They may be blocked with conventional blocking agents that can be de-blocked under the action of heat, for example, with alcohols, oximes, amines and/or CH-acidic compounds.

The blocked or preferably free polyisocyanates may be used as such or as a preparation containing water and/or organic solvent, wherein in the case of free polyisocyanate no water and no organic solvent with active hydrogen is used. It may be desirable, for example, for the polyisocyanates to be pre-diluted with a water-miscible organic solvent or solvent mixture. In this case, it is preferable to use solvents, which are inert relative to isocyanate groups, especially where the preferred free polyisocyanates are used. Examples are solvents which do not contain any active hydrogen, for example, ethers, such as, for example, diethylene glycol diethyl ether, dipropylene glycol dimethyl ether; glycol ether esters, such as, ethylene glycol monobutyl ether acetate, diethylene glycol monobutyl ether acetate, methoxypropyl acetate; and N-methylpyrrolidone.

Also suitable are hydrophilic polyisocyanates, which may be stabilized in the aqueous phase by a sufficient number of ionic groups and/or by terminal or lateral polyether chains. Hydrophilic polyisocyanates are sold as commercial products, for example, by Bayer under the name Bayhydur®.

The admixture component exhibits a ratio by weight of pigment content to resin solids content of 0.05:1 to 0.5:1, in particular, of 0.1:1 to 0.4:1. The sum of the solids contents contributed by the pigment content and the resin solids content is, for example, 20 to 100 wt. %, in general, 30 to 95 wt. %, in particular, 45 to 95 wt. %, specifically 55 to 95 wt. % of the admixture component.

The pigment content of the admixture component comprises at least one pigment, which effectively reduces UV transmission. The pigment content is made in such a manner that, with a given unmodified water-borne base coat, a given mixing ratio of admixture component and unmodified water-borne base coat in the range from 0.2 to 1, preferably, 0.2 to 0.8 parts by weight of polyisocyanate: 1 part by weight of resin solids of the unmodified water-borne base coat and a given ratio by weight of pigment content to resin solids content of 0.05:1 to 0.5:1 in the admixture component, UV light can penetrate through the base coat layer applied in process film thickness and consisting of the modified water-borne base coat and the unmodified water-borne base coat only in accordance with a UV transmission of less than 0.1% in the wavelength range of from 280 to 380 nm and of less than 0.5% in the wavelength range of from 380 to 400 nm. In other words, the pigment content comprises at least one pigment which effectively reduces UV transmission and moreover has a qualitative and quantitative composition such that, with a given unmodified water-borne base coat, a given mixing ratio of admixture component and unmodified water-borne base coat and a given ratio by weight of pigment content to resin solids content, in each case in the stated ranges, UV light can penetrate through the base coat layer applied in process film thickness and consisting of the modified water-borne base coat and the unmodified water-borne base coat only in accordance with a UV transmission of less than 0.1% in the wavelength range of from 280 to 380 nm and of less than 0.5% in the wavelength range of from 380 to 400 nm. In addition to the at least one pigment which effectively reduces UV transmission, the pigment content of the admixture component may also comprise other pigments. In general, however, the pigment content consists solely of one or more pigments which effectively reduce(s) UV transmission.

Examples of pigments which effectively reduce UV transmission and may be used alone or in combination in the pigment content of the admixture component are in particular carbon black, titanium dioxide, iron oxide pigments and aluminum flake pigments, the latter in particular with average particle sizes, for example, in the range from 1 to 15 μm at flake thicknesses of, for example, 100 nm to 1 μm.

Examples of pigment contents of a particularly suitable composition with regard to the desired reduction in UV transmission and for the purposes of the process according to the invention are pigment contents consisting of 0 to 100 wt. % of carbon black, 0 to 100 wt. % of titanium dioxide, 0 to 100 wt. % of one or more aluminum flake pigments, for example, one or more of the aluminum flake pigments stated in the preceding paragraph, 0 to 100 wt. % of one or more iron oxide pigments and 0 to 90 wt. % of one or more other pigments, wherein the weight percentages add up to 100 wt. %. Preferred pigment contents are those consisting of 0 to 100 wt. % of carbon black, 0 to 100 wt. % of titanium dioxide and 0 to 100 wt. % of one or more aluminum flake pigments and in particular, pigment contents enabling various grey shades consisting of 0.1 to 10 wt. % of carbon black and 90 to 99.9 wt. % of titanium dioxide, wherein the weight percentages in each case add up to 100 wt. %.

In general, the pigment or pigments forming the pigment content of the admixture component are ground. Grinding may be performed in conventional assemblies known to the person skilled in the art. The pigments may be ground in the presence of the polyisocyanate, i.e., directly in the polyisocyanate as such or in the polyisocyanate as an organic and/or aqueous solution or an aqueous dispersion. One or more grinding resins may here be added as grinding auxiliaries. Alternatively and in general also preferably, it is however also possible to perform grinding in a separate grinding medium in the form of a grinding resin or a mixture of grinding resins. In particular, when producing the preferred admixture components containing free polyisocyanate, it is expedient to use a separate grinding medium.

Grinding resins suitable as a grinding auxiliary or separate grinding medium are those which are inert during grinding of the pigments, on mixing with the further constituents of the admixture component, in particular on mixing with the free or blocked polyisocyanate and on further mixing with the unmodified water-borne base coat as well as in the finished modified water-borne base coat, for example, appropriate (meth)acrylic copolymer or polyurethane resins.

In particular, in the case of the production of the preferred admixture components containing free polyisocyanate, grinding resins which are inert towards isocyanate groups are used as the grinding auxiliary or, in particular, as the grinding medium. Completely etherified amino resins, in particular, completely etherified melamine resins, such as, in particular, hexamethoxymethylmelamine, have surprisingly proved highly suitable for this purpose. Grinding here preferably proceeds in the completely etherified amino resin in the absence of the free polyisocyanate, for example, in a solids weight ratio of pigments to completely etherified amino resin of 0.1:1 to 3:1, said ratio being dependent inter alia on the nature of the pigment(s) used.

Particularly preferred admixture components in the context of the preceding paragraph have a resin solids content consisting of a combination amounting to 100 wt. % of 1 to 15 wt. % of completely etherified amino resin and 85 to 99 wt. % of polyisocyanate, in particular free polyisocyanate.

Aluminum flake pigments are not ground, but instead generally initially introduced in the form of a conventional commercial non-aqueous paste, optionally, combined with preferably water-dilutable organic solvents and optionally, additives and then mixed with the polyisocyanate(s). Pulverulent aluminum flake pigments may first be processed with preferably water-dilutable organic solvents and optionally additives to yield a paste.

Once the pigment preparations have been produced, they are made up into the finished admixture component by being mixed with any remaining or missing constituents. In particular, if grinding was not performed in the presence of the polyisocyanate, the latter is mixed in to yield the finished admixture component.

When producing the preferred admixture components containing free polyisocyanate, it is expedient not only to avoid the deliberate addition of water, but also to perform processing with the most extensive possible, preferably complete, exclusion of water and in general also with the most extensive possible, preferably complete, exclusion of other substances reactive towards isocyanate groups, such as, for example, alcohols. Apart from selecting appropriate raw materials, it is additionally possible to work with water-binding auxiliaries. For example, water scavengers, such as, orthoesters may be added during production and storage of the admixture components containing free polyisocyanate.

The admixture component may optionally contain one or more fillers, for example, 0 to 10 wt. %, relative to the solids content. Examples of fillers usable in the admixture component are barium sulfate, kaolin, talcum, silicon dioxide, layered silicates.

The admixture component may, if it contains no free polyisocyanate, contain, for example, 20 to 70 wt. % water. The water may here have entered the admixture component in various ways, for example, by addition as such or as a constituent of a separate grinding medium.

The admixture component may contain one or more organic solvents, for example, in a total quantity of 5 to 70 wt. %. The solvents are preferably water-dilutable. In the case of the preferred admixture components containing free polyisocyanate, the solvents are those which are inert towards isocyanate groups. Examples of suitable solvents are ethers, such as, for example, diethylene glycol diethyl ether, dipropylene glycol dimethyl ether; glycol ether esters, such as, ethylene glycol monobutyl ether acetate, diethylene glycol monobutyl ether acetate, methoxypropyl acetate; and N-methylpyrrolidone. The solvent may here have entered the admixture component in various ways, for example, by addition as such or as a constituent of prediluted polyisocyanate.

In addition to the at least one polyisocyanate and the pigment(s) forming the pigment content and in each case optional constituents fillers, water, organic solvent and grinding resin, the admixture component may contain additives in proportions of in each case, for example, 0.1 to 2 wt. %, corresponding a total quantity of in general no more than 5 wt. %. Examples of additives are defoamers, anticratering agents, wetting agents, neutralizing agents. The admixture component may, although not preferably, contain light stabilizers, for example, UV absorbers and/or HALS-based compounds. If the admixture component contains light stabilizers, these are not crucial to UV light being able to penetrate through the base coat layer formed from modified water-borne base coat and unmodified water-borne base coat only in accordance with a UV transmission of less than 0.1% in the wavelength range of from 280 to 380 nm and of less than 0.5% in the wavelength range of from 380 to 400 nm. This effect is instead, in particular with regard to the durability thereof, achieved by the pigment content of the admixture component.

As already mentioned above, the process according to the invention may expediently be performed with an admixture component the pigment content whereof has been adjusted relative to the color shade of the unmodified water-borne base coat. To this end, it is possible either to work with a single admixture component which has been pigmented by way of a compromise with the color shade programme of the unmodified water-borne base coats used or, alternatively, also to use two or more differently pigmented admixture components. In the latter case, it is of course possible to achieve a greater degree of color shade adjustment between the individual unmodified water-borne base coats and the admixture components by the formation and assignment of appropriate color groups of unmodified water-borne base coats to in each case one of the differently pigmented admixture components.

In the process according to the invention, the admixture component is mixed with the unmodified water-borne base coat in a ratio by weight of 0.2 to 1, preferably 0.2 to 0.8 parts of polyisocyanate: 1 part of resin solids of the unmodified water-borne base coat.

The process according to the invention is preferably performed with unmodified water-borne base coats which comprise a resin solids content comprising one or more hydroxy-functional binders. The hydroxyl value of the resin solids content of the unmodified water-borne base coat is, for example, in the range of from 10 to 150 mg KOH/g, the NCO/OH molar ratio in the modified water-borne base coat is, for example, 0.5:1 to 25:1. However, in the case of unmodified water-borne base coats with a low-hydroxyl or hydroxyl-free resin solids content, higher NCO/OH molar ratios may also arise in the corresponding modified water-borne base coats. For example, the NCO/OH molar ratios may even extend towards infinity. In such cases, the polyisocyanate in the modified water-borne base coat is consumed by reaction with other constituents, which are reactive in relation to isocyanate groups, for example, with water, hydroxy-functional solvents and/or with functional groups of binders which are reactive relative to isocyanate and are different from hydroxyl groups.

In the process according to the invention, the EDC-primed substrates are initially spray-coated with the modified water-borne base coat in a dry film thickness of, for example, 5 to 25 μm. This is preferably performed using electrostatically-assisted high-speed rotary atomization.

Then, preferably after a brief flash-off phase of, for example, 30 seconds to 5 minutes at an air temperature of 20 to 25° C., the corresponding unmodified water-borne base coat is spray-applied in a dry film thickness of, for example, 3 to 15 μm. This spray application is preferably pneumatic spray application.

This is preferably also followed by a brief flash-off phase of, for example, 30 seconds to 10 minutes at an air temperature of 20 to 100° C., after which the clear coat is applied in a dry film thickness of, for example, 20 to 60 μm.

All known clear coats are in principle suitable as the clear coat. Usable clear coats are both solvent-containing one-component (1 pack) or two-component (2 pack) clear coats, water-dilutable 1 pack or 2 pack clear coats, powder clear coats or aqueous powder clear coat slurries.

After an optional flash-off phase, the applied water-borne base coat layer consisting of modified and unmodified water-borne base coat and the clear coat layer are jointly cured, for example, by baking, for example, at 80 to 160° C. object temperature.

Using the process according to the invention, EDC-primed substrates may be provided with a primer surfacer-free coating. Any destructive access of UV light though the clear coat and the base coat layer applied from the modified and the unmodified water-borne base coat to the EDC primer may here be prevented, despite the base coat layer being applied in a process film thickness of only 10 to 35 μm. Although pigmented admixture components are mixed into the unmodified water-borne base coats during production of the modified water-borne base coats, it is possible with the process according to the invention to produce multi-layer coatings of the desired color shade. Application and baking of a primer surfacer layer is not necessary and the technological properties of the multi-layer coatings meet the requirements of car manufacturers.

The following Examples illustrate the invention. All parts and percentages are on a weight basis unless otherwise indicated.

### EXAMPLES

### Example 1

### Production of an Admixture Component

A pigmented admixture component of the following composition was produced:

18.2 parts by weight of titanium dioxide (TiPure® R 706 from DuPont)

0.5 parts by weight of carbon black (Raven® 410 D from Columbian Carbon)

10.0 parts by weight of hexamethoxymethylmelamine

28.8 parts by weight of N-methylpyrrolidone

27.9 parts by weight of a hydrophilic aliphatic polyisocyanate based on hexamethylene diisocyanate with an NCO value of 17.4

14.6 parts by weight of trimerized hexamethylene diisocyanate with an NCO value of 23.

The titanium dioxide and the carbon black were ground in a bead mill in the hexamethoxymethylmelamine. One third of the N-methylpyrrolidone was used to adjust viscosity. The resultant mill base was intimately mixed with the remaining N-methylpyrrolidone and the two polyisocyanates.

### Example 2

A mixture of 10.0 parts by weight of hexamethoxymethylmelamine, 28.8 parts by weight of N-methylpyrrolidone, 27.9 parts by weight of the hydrophilic aliphatic polyisocyanate based on hexamethylene diisocyanate with an NCO value of 17.4 and 14.6 parts by weight of the trimerized hexamethylene diisocyanate with an NCO value of 23 was produced.

### Example 3

a) A blue, unmodified, mica pigment-containing water-borne base coat of the following composition was produced:

10.2 parts by weight of resin solids (5.2 parts by weight of a polyester polyurethane resin, 2.1 parts by weight of a polyester acrylate resin, 1 part by weight of a polyurethane resin, 1.9 parts by weight of hexamethoxymethylmelamine; hydroxyl value of the resin solids 40.8 mg of KOH/g)

2.8 parts by weight of mica pigments (2.4 parts by weight of Iriodin® SW 9221 Rutile Fine Blue from Merck; 0.4 parts by weight of EXT Merlin Lumina Turquoise T303D from Mearl-Engelhard)

0.3 parts by weight of PALIOGENBLAU® L 6480 from BASF

0.1 parts by weight of HELIOGENBLAU® L 6930 from BASF

0.5 parts by weight of HOSTAPERMROSA® E from Clariant

0.3 parts by weight of PALIOGENBLAU® L.6385 from BASF

0.1 parts by weight of carbon black FW 200F from Degussa

1.0 part by weight of talcum

0.2 parts by weight of dimethylethanolamine

0.5 parts by weight of defoamer

0.6 parts by weight of polyacrylic acid thickener

0.8 parts by weight of polypropylene glycol 400

12.4 parts by weight of organic solvents (6.5 parts by weight of ethylene glycol monobutyl ether, 0.8 parts by weight of ethylene glycol monohexyl ether, 0.6 parts by weight of N-methylpyrrolidone, 1.5 parts by weight of n-butanol, 2.5 parts by weight of n-propanol, 0.5 parts by weight of Shellsol T)

70.2 parts by weight of water.

b) A modified water-borne base coat was produced by mixing 100 parts by weight of the unmodified water-borne base coat from a) with 10 parts by weight of the admixture component from Example 1.

c) A modified water-borne base coat was produced by mixing 100 parts by weight of the unmodified water-borne base coat from a) with 8.13 parts by weight of the mixture from Example 2.

### Example 4

a) A silver-colored, unmodified water-borne base coat of the following composition was produced:

11.2 parts by weight of resin solids (5.4 parts by weight of a polyester polyurethane resin, 5.8 parts by weight of a polyester acrylate resin; hydroxyl value of the resin solids 38.5 mg of KOH/g)

3.0 parts by weight of non-leafing aluminum pigments (1.19 parts by weight of Stapa Hydrolac® WHH 2154,1.19 parts by weight of Stapa Hydrolac® WHH 2156, 0.72 parts by weight of Stapa Hydrolac® WHH 44668; Hydrolac®, aluminum pigments from Eckart)

0.2 parts by weight of dimethylethanolamine

0.5 parts by weight of defoamer

0.6 parts by weight of polyacrylic acid thickener

1.2 parts by weight of polypropylene glycol 400

12.1 parts by weight of organic solvents (6.6 parts by weight of ethylene glycol monobutyl ether, 0.8 parts by weight of N-methylpyrrolidone, 2.3 parts by weight of n-butanol, 2.4 parts by weight of n-propanol)

71.2 parts by weight of water.

b) A modified water-borne base coat was produced by mixing 100 parts by weight of the unmodified water-borne base coat from a) with 10 parts by weight of the admixture component from Example 1.

c) A modified water-borne base coat was produced by mixing 100 parts by weight of the unmodified water-borne base coat from a) with 8.13 parts by weight of the mixture from Example 2.

### Example 5

### Measurement of the UV Transmission of Base Coat Layers

The modified water-borne base coats 3b and 3c and 4b and 4c respectively were each applied to a quartz glass plate by means of electrostatically-assisted high-speed rotary atomization (3b and 3c in each case to a dry film thickness of 17 μm; 4b and 4c in each case to a dry film thickness of 15 μm).

After 2 minutes flashing off at room temperature, the corresponding unmodified water-borne base coats 3a and 4a respectively were each pneumatically spray-applied in a 5 μm dry film thickness, flashed off for 5 minutes at 70° C. and baked for 15 minutes at 140° C.

Then, the UV transmission of the silica glass plates coated in this way with base coat layers was photometrically determined (uncoated silica glass plate in reference beam path; UV irradiation from the coated side).

The results are shown in Table 1.

TABLE 1
UV transmission in the wavelength range

| | 280 to 380 nm | 380 to 400 nm |
|---|---|---|
| Water-borne base coat | Between 0 and 0.08% | 0.08 to 0.45% |
| 3b + 3a | | |
| Water-borne base coat | Between 0 and 0.27% | 0.27 to 1.03% |
| 3c + 3a | | |
| Water-borne base coat | Between 0 and 0.06% | 0.06 to 0.3% |
| 4b + 4a | | |
| Water-borne base coat | Between 0 and 0.21% | 0.21 to 0.24% |
| 4c + 4a | | |

The base coat structures 3b+3a and 4b+4a, each prepared making use of the pigmented admixture component of Example 1 allowed a UV transmission of only less than 0.1% in the wavelength range of from 280 to 380 nm and of less than 0.5% in the wavelength range of from 380 to 400 nm. The base coat structures 3c+3a and 4c+4a, each prepared making use of the un-pigmented admixture component of Example 2 exceeded that UV transmission limitation.

### Example 6

### Production of Multi-Layer Coatings and Technological Tests

The modified water-borne base coats 3b and 4b respectively were each applied to steel test panels provided with an EDC primer by means of electrostatically-assisted high-speed rotary atomization (3b to a dry film thickness of 17 μm; 4b to a dry film thickness of 15 μm).

After flashing-off for 2 minutes at room temperature the corresponding unmodified water-borne base coats 3a and 4a respectively were each spray-applied pneumatically in 5 μm dry film thickness and allowed to flash-off for 5 minutes at 70° C.

The test panels provided in this way with a flashed off base coat layer were then further coated in various ways.

a) Test panels with the base coat structures 3b+3a and 4b+4a respectively were each baked for 20 minutes at 125° C. object temperature (simulation of multi-layer coatings without final clear coat layer, as e.g., in the engine compartment or the trunk of automotive bodies).

b) Test panels with the base coat structures 3b+3a and 4b+4a respectively were each spray coated with a commercial two-component polyurethane clear coat in 40 μm layer thickness and after flashing-off for 5 minutes at 20° C. baked for 20 minutes at 125° C. object temperature.

c) The same procedure was observed as in Example 6b). Thereafter the same coating structures of modified and unmodified water-borne base coats and two-component polyurethane clear coat were applied again and under the same conditions as before (simulation of a repair coating).

d) Test panels with the base coat structures 3b+3a and 4b+4a respectively were each spray coated with a two-component polyurethane clear coat in 40 μm layer thickness and after flashing-off for 5 minutes at 20° C. baked for 30 minutes at 1 60° C. object temperature (simulation of over-bake conditions). The test panels produced in this way were subjected to technological tests the results of which are shown in Table 2.

TABLE 2

| | | | | | Humidity | |
|---|---|---|---|---|---|---|
| | Steam jet | | | | resistance | |
| | resistance | | Stone chip | | (cross-cut | |
| | (in mm) ¹⁾ | | resistance ²⁾ | | adhesion) ³) | |
| Coating | 2 cm | 15 cm | +20° C. | -20° C. | before | after |
| 6a (3b + 3a) | 2.5 | 0.3 | | | | |
| 6a (4b + 4a) | 2.2 | 0.2 | | | | |
| 6b (3b + 3a) | 1.5 | 0 | 1 | 1 | 0 | 0 |
| 6b (4b + 4a) | 4.2 | 0 | 1.5 | 1.5 | 0 | 0 |
| 6c (3b + 3a) | | | 1 | 1 | 0 | 0 |
| 6c (4b + 4a) | | | 1.5 | 1.5 | 0 | 0 |
| 6d (3b + 3a) | 3.0 | 0 | 1.0 | 1.5 | | |
| 6d (4b + 4a) | 4.6 | 0 | 1.5 | 1.5 | | |

1) Steam Jet Test

The effect of cleaning with a steam jet appliance was simulated by the test panel provided previously with an X-cut (diagonal cross) according to DIN EN ISO 7253 being exposed at the crossing point of the diagonal cross for 20 seconds at a nozzle distance of 2 cm or 15 cm to a steam jet of 90 bar (operating pressure) and 65° C. (measured 10 cm before the nozzle) with a spraying angle of 90 degrees. The coating delamination was assessed from the side of the diagonal cross in mm.

2) Stone Chip Resistance (DIN 55996-1)

The testing was carried out by means of stone chip test equipment according to VDA (firm Erichsen, model 508; test conditions: 2×500 g steel grit 4-5 mm sharp-edged, 2 bar) at +20° C. and at −20° C. Evaluation of the damage (indicator 0=no spalling, indicator 5=complete detachment).

3) Adhesion test before/after exposure to condensation in a humidity cabinet

An exposure to condensation took place first of all according to DIN 50 01 7-KK, for a period of 240 h, 24 h conditioning at room temperature. The adhesion was tested before and after this exposure to condensation by cross-cut test according to DIN EN ISO 2409 (with the 2 mm multi-blade tool). The evaluation is made by comparison with damage patterns, low ratings correspond to better results here.

What is claimed is:

1. A process for the production of multi-layer coatings, comprising the successive steps:
1) applying a 10 to 35 μm thick base coat layer onto a substrate provided with an EDC primer,
2) applying a clear coat layer onto the base coat layer,
3) jointly curing the base coat and clear coat layers,
wherein the base coat layer is applied in a first layer and in a second layer; the first layer comprises a modified water-borne base coat produced by mixing an unmodified water-borne base coat with a pigmented admixture component and the second layer comprises the unmodified water-borne base coat,
wherein the admixture component contains at least one polyisocyanate, has a ratio by weight of pigment content to resin solids content of 0.05:1 to 0.5:1 and is mixed into the unmodified water-borne base coat in a ratio by weight of 0.2 to 1 parts of polyisocyanate :1 part of resin solids of the unmodified water-borne base coat,
wherein the pigment content of the admixture component comprises at least one pigment which effectively reduces UV transmission and wherein the pigment content being such that UV light can penetrate through the base coat layer formed from modified water-borne base coat and unmodified water-borne base coat only in accordance with a UV transmission of less than 0.1% in the wavelength range of from 280 to 380 nm and of less than 0.5% in the wavelength range of from 380 to 400 nm.

2. The process of claim 1, wherein the unmodified water-borne base coat comprises a resin solids content comprising at least one hydroxy-functional binder corresponding to a hydroxyl value of the resin solids content of 10 to 150 mg of KOH/g.

3. The process of claim 1, wherein the ratio by weight of pigment content to resin solids content of the admixture component is 0.1:1 to 0.4:1.

4. The process of claim 1, wherein the substrates comprise substrates selected from the group consisting of automotive bodies and body parts.

5. The process of claim 1, wherein the modified water-borne base coat is applied to a film thickness of 5 to 25 μm and the unmodified water-borne base coat to a film thickness of 3 to 15 μm.

6. The process of claim 1, wherein the admixture component comprises a solids content of 30 to 100 wt. % and the solids content consists of the resin solids content, the pigments forming the pigment content, optionally, extenders and optionally, non-volatile additives.

7. The process of claim 1, wherein the at least one pigment which effectively reduces UV transmission is selected from the group consisting of carbon black, titanium dioxide, iron oxide pigments, aluminum flake pigments and combinations thereof.

8. The process of claim 1, wherein the pigment content of the admixture component consists of
0 to 100 wt. % of carbon black,
0 to 100 wt. % of titanium dioxide,
0 to 100 wt. % of one or more aluminum flake pigments,
0 to 100 wt. % of one or more iron oxide pigments and
0 to 90 wt. % of one or more other pigments,
wherein the weight percentages add up to 100 wt. %.

9. The process of claim 1, wherein the pigment content of the admixture component consists of
0 to 100 wt. % of carbon black,
0 to 100 wt. % of titanium dioxide and
0 to 100 wt. % of one or more aluminum flake pigments,
wherein the weight percentages add up to 100 wt. %.

10. The process of claim 1, wherein the pigment content of the admixture component consists of
0.1 to 10 wt. % of carbon black and
90 to 99.9 wt. % of titanium dioxide,
wherein the weight percentages add up to 100 wt. %.

11. The process of claim 1, wherein the pigment(s) forming the pigment content of the admixture component has/have been ground in the presence of the at least one polyisocyanate.

12. The process of claim 1, wherein the pigment(s) forming the pigment content of the admixture component has/have been ground in the presence of a grinding resin and in the absence of the at least one polyisocyanate.

13. The process of claim 12, wherein the grinding resin comprises a completely etherified amino resin.

14. The process of claim 1, wherein the at least one polyisocyanate is a free polyisocyanate.

15. A substrate coated according to the process of claim 1.
